(19) United States
(12) Patent Application Publication
(10) Pub. No.: US 2007/0047506 A1
(43) Pub. Date: Mar. 1, 2007

(54) Methods and devices for dynamically adjusting page scan intervals of bluetooth enabled devices

(76) Inventors: Timothy P. Froehling, Palatine, IL (US); Erick D. Loven, Mahomet, IL (US); Meinrad Steiner, Poway, CA (US)

Correspondence Address: MOTOROLA INC, 600 NORTH US HIGHWAY 45, ROOM AS437, LIBERTYVILLE, IL, 60048-5343, US

(21) Appl. No.: 11/216,944

(22) Filed: Aug. 31, 2005

(51) Int. Cl. H04Q 7/24

(52) U.S. Cl. 370/338; 370/311

(57) ABSTRACT

Described is a method for regulating power consumption during page scanning operations in a Bluetooth enabled communication device (102) having a power source (118) and a processor (120) that is configured to communicate according to a plurality of page scanning intervals. The method include assessing trigger events (304, 306) to dynamically adjust page scanning interval output values (308) and accordingly adjusting a power consumption level in accordance with the page scanning interval output values. The variable page scanning intervals change from idle, slow and fast according to their type.

### FIELD OF THE INVENTION

Disclosed is a method and Bluetooth enabled device for dynamically adjusting page scan intervals of the slave device and more particularly, processing variable page scan rates to reduce power consumption of the slave and increase connection responsiveness.

### BACKGROUND OF THE INVENTION

Bluetooth enabled communication devices often include battery packs for portability and wireless capability. The time between battery charges depends upon the amount of energy consumed during the device's operation and the battery configuration. Energy consumption often depends upon the activity of the portable device.

Bluetooth is a wireless communications protocol that is being used in many kinds of communication devices. Bluetooth includes a set of specifications for transmitting and receiving data packets. Bluetooth enabled communication devices include, for example cellular telephones, PDAs, computers, mice and headsets. Bluetooth is becoming preferred by many industries due to its robustness and immunity to signal interference.

The amount of current drain during certain Bluetooth controller states is higher in some operational states than in others. There are a number of states, or substates, that exist between standby and connection. A sequence of substates can prepare a slave device for receiving data from a master. These substates include, for example, page, page scan, inquiry, inquiry scan, master response, slave response, and inquiry response. In the connection state there are a plurality of substates including, for example, active, sniff, hold and park. Additionally, each of these states has varying degrees.

Normally, to establish a connection between two devices, for example, between master and slave devices, a Bluetooth slave device will listen for inquiries (i.e. inquiry scan substate) to which it responds by sending its address and clock information (FHS packet) to the master (inquiry response substate). After sending the information, the slave may start listening for page messages from the master (page scan). The master after finding an in range Bluetooth device will respond (slave response substate) with its device access code (DAC). Other information may be transmitted prior to the devices entering into their connection states.

The page scan state generally has a periodic interval. Bluetooth enabled devices generally operate with two different power consumption modes, standby and connection. While between standby and connection there are seven different substates, there are two power consumption options, a low of standby or a high of connection. A tradeoff exists between the time required to build up an active Bluetooth connection and the average power required to maintain that connection (or to look for new incoming connections) in a standby state.

In standby or idle mode, power consumption can be made very small by allowing the transition time to an active connection state to be very long. Conversely, the time required to transition to active connection state can be made very short by increasing the amount of standby power consumed. Neither solution is desirable for many Bluetooth-capable portable and mobile communication devices. As with any power consuming device, it would be beneficial to reduce the amount of power required to run the device while either maintaining or increasing its responsiveness.

### BRIEF DESCRIPTION OF THE DRAWINGS

FIG. 1 is an embodiment of an electronic device including a Bluetooth master-slave configuration;

FIG. 2 is a state flow diagram of an embodiment of the disclosed dynamic page scanning method;

FIG. 3 is a flow chart of an embodiment of the method for regulating power consumption during page scanning operations in a Bluetooth enabled communication device;

FIG. 4 shows a dynamic page scan flow for an incoming call;

FIG. 5 shows a dynamic page scan flow for an outgoing call; and

FIG. 6 shows a dynamic page scan flow for incoming voicemail.

### DETAILED DESCRIPTION OF THE INVENTION

A Bluetooth-enabled (BT) communication device and method as described in detail below includes a circuit for regulating power during page scanning operations. The circuit includes modules of any configuration that provide power to the device and includes a processor that controls the Bluetooth states. The device may be a slave device in the Bluetooth scheme, however, may also be a master-slave combination device. The power source is configured to provide power output to the device and the processor is configured to adjust a page scanning interval in the Bluetooth enabled device to generate a plurality of page scanning intervals. The device draws upon the power source that is further configured to provide power output including a plurality of power output levels that corresponds to the plurality of page scanning intervals. The page scanning intervals vary in time and are adjusted dynamically in accordance with a plurality of trigger events so that power consumption is also dynamically modified.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

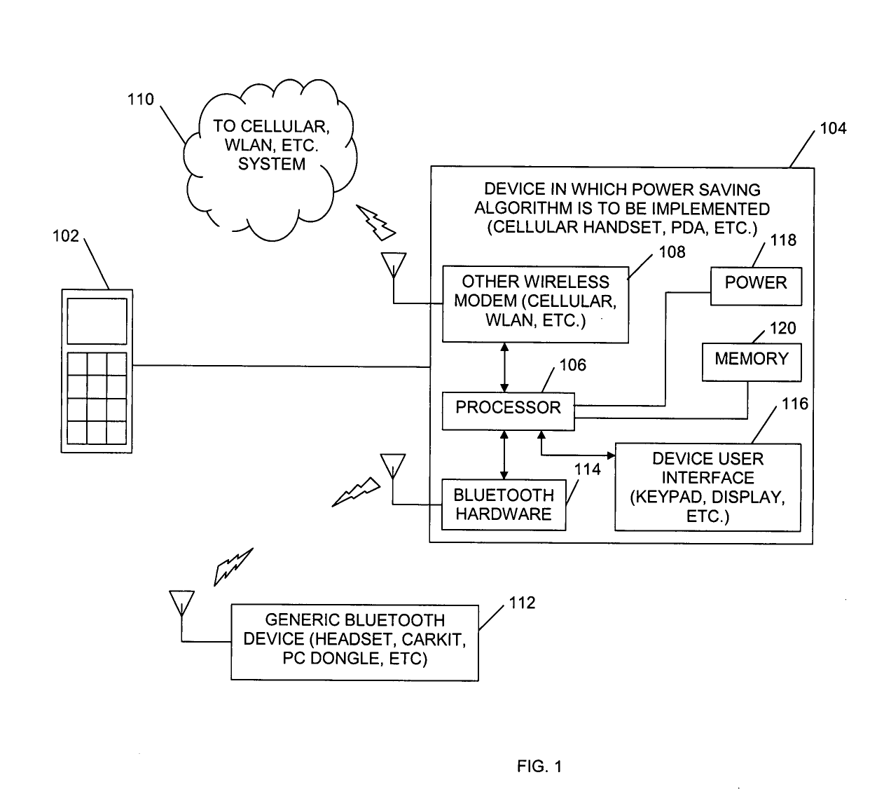

FIG. 1 shows a Bluetooth enabled communication device 102 that is depicted as a wireless handset or cellular telephone. A wide variety of handheld wireless devices include, for example, pagers, radios, personal digital assistants (PDAs), notebook or laptop computers incorporating wireless modems, mobile data terminals, application specific gaming devices and video gaming devices. The Bluetooth protocol is further used in wireless computer mice and headsets that may be in communication with a telephone or computer, to name a few. Stationary and other devices may implement the described method and circuitry as well.

FIG. 1 further depicts some circuitry modules 104 of the cellular device 102. The processor 106 may be configured in any manner, that is, it may be a single component or more than one. The cellular device depicted here includes a receiver-transmitter 108 that may be in communication with for example a cellular or WLAN system 110. The processor is further in communication with one or more generic Bluetooth devices 112 such as, for example, a headset, a carkit, a PC dongle via Bluetooth hardware 114. The previously mentioned generic Bluetooth devices are used within short range of the Bluetooth hardware 114 since Bluetooth is typically used as a short distance communication protocol, however, long distance uses are considered within the scope of this discussion.

The processor is further in communication with user interface devices such as input devices and output devices 116. Additionally, the processor is configured to receive power from the power source 118 and instructions from memory 120. As with the processor, these modules may be configured in any manner.

The electronic device 102 can receive communication signals from, for example, a cellular network. The signals are processed by the processor 106 so that they can be distributed via the Bluetooth transmitter/receiver hardware 114 to the generic Bluetooth device 112, such as a headset. In this exemplary embodiment, the Bluetooth hardware 114 is the master in a cellular telephone and the generic Bluetooth device 112 is the slave in a headset accessory. Accordingly, the electronic device 102 can process incoming and outgoing cellular signals. As in signal exchanges of other master and slave applications, the Bluetooth slave device will listen for inquiries (inquiry scan substate) and respond by sending its address and clock information (FHS packet) to the master (inquiry response substate). After sending the information, the slave may start listening for page messages from the master (page scan). The pages are for connection set up. The page state is used by the master to activate and connect the slave. In the page state, the master sends page messages that include an intended slave's Device Access Code (DAC). These operations correspond to the slave transitioning from the idle mode to the active mode.

Alternatively, when there is user input (UI) to the slave, the slave also changes from idle mode to active mode. During these operations, the slave seeks to establish a connection with the master by entering into page scanning mode in a manner similar to that described above.

In the cellular handset and headset embodiment, as in other master-slave applications, there are different types of page scans. The page scan rate generated by the slave is determined by the desired responsiveness in the connection between the devices and the expense of the power consumption for that responsiveness. The certain categories of page scans provide for variable page scan intervals, slow, intermediate and fast, and variations therebetween.

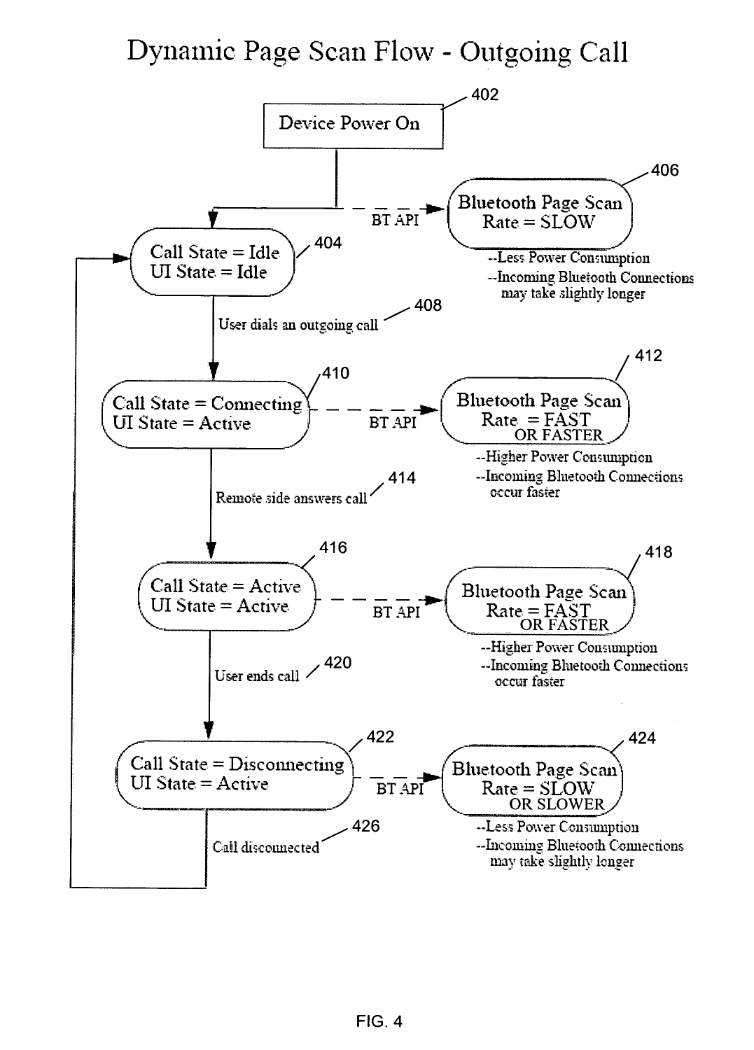

There are many different device states which can be matched to different page scan rates. Briefly referring to FIGS. 4, 5 and 6, they show embodiments for page scan such as “Call State=Idle; UI State=Idle,” “Call State=Connecting; UI State=Active,” “Call State=Active; UI State=Active,” “Call State=Disconnecting; UI State=Active,” “Call State=Ringing; UI State=Active,” “Call State=Idle; UI State=Active.” In this description two sub-system states can define the overall communication device's state. Many more sub-systems can have an impact on the device's state, for example, “Battery State=Charging/Discharging,” “Local Cable=Connected/Disconnected,” “Phone Flip=Open/Closed.”

To access the page scans of the states and sub-states, the adjustment values for the page rates may be stored in a table for example, or may be generated according to an algorithm based on the device's sub-system states. An algorithm to dynamically adjust the page scan rate and in response power consumption may take into account many different factors as described herein.

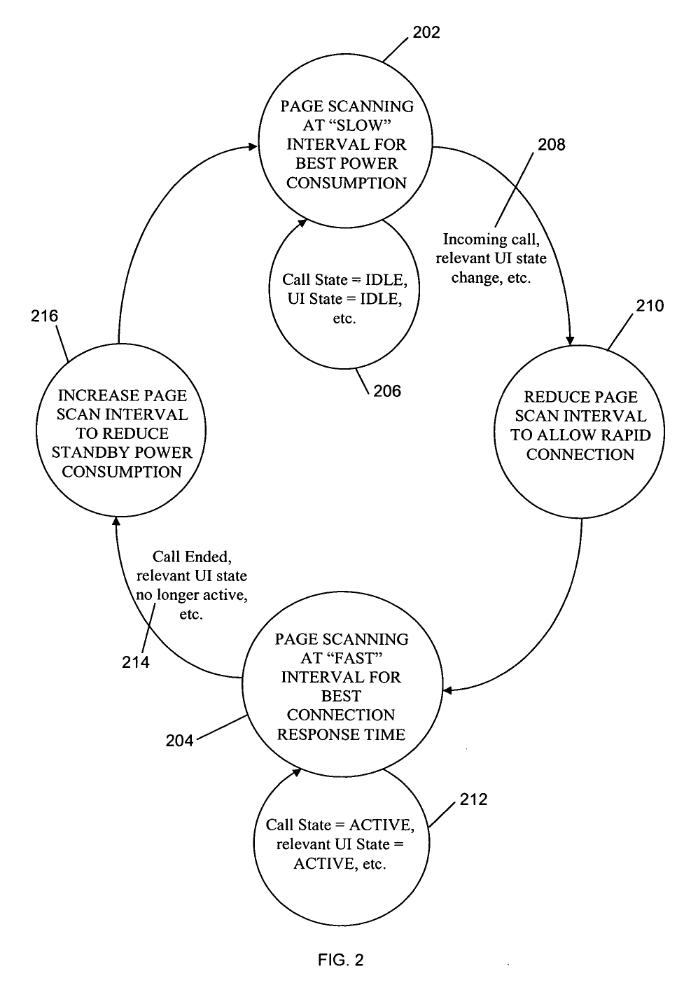

FIG. 2 is a state flow diagram that shows an embodiment of page scanning, first at a slow interval 202, then to a page scanning at a fast interval 204 and then back again. At the slow or long interval, the power consumption is at its lowest. The call state is idle and the user interface (UI) state is idle 206. Trigger events such as an incoming call or a relevant UI state change 208 reduce the page scan interval to allow for a rapid connection. The page scan interval 204 is a fast interval when the call state is active or there is an active relevant UI 212. Again, the page scan interval between 210 and 204 can change several times as it is reduced, becoming smaller and smaller.

In the reverse situation, the page scan interval 204 is a fast interval when the call state is active or there is an active relevant UI 212. Trigger events such as a call ending or a relevant UI state change 214 increases the page scan interval to reduce standby power consumption 216. The page scan interval between 204 and 216 can change several times as it is increased, becoming larger and larger. The page scanning can slow to a long interval for optimum power consumption 202 when its call state and UI state are idle 206.

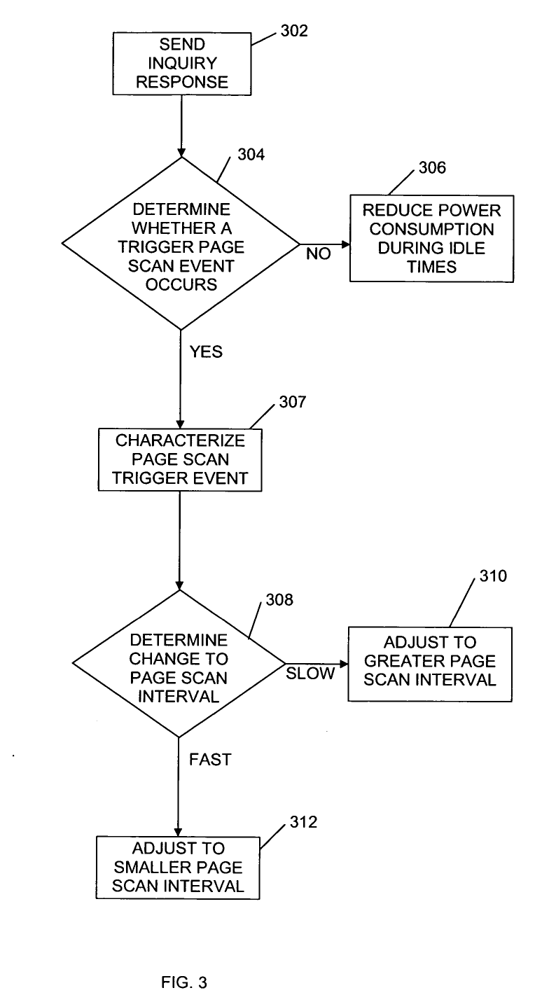

Turning to FIG. 3, a flow chart is shown of an embodiment of the method for regulating power consumption during page scanning operations in a Bluetooth enabled communication device. Other applications such as a computer and a mouse operate in much the same manner.

As described above there can be a sequence of inquiry communications between the devices. An inquiry response is sent by the slave 302. After sending the inquiry response, the slave may start listening for page messages from the master (page scan). As a page is detected during, for example, a page scan of a very slow interval (a state that is idle), a query is made as to whether the page scan event will trigger an increase page scan frequency 304. If not, the reduced power consumption will be maintained during the idle time 306. If yes, the method can include a characterization of the page scan event 307. The characterization 307 can be combined with the following step 308. Next there can be determination of whether to change the page scan interval 308 to either a slow page scan interval which will avoid high power consumption 310 or a fast page scan interval which will increase responsiveness 312 and may maintain a low power consumption as well.

FIGS. 4, 5 and 6 illustrate different embodiments of the dynamic page scan flow for particular page scan events, including an outgoing call, an incoming call and an incoming voicemail. In each example there is a call state and a UI state. The combination of the two, either in different states or similar states can further cause modifications to the page scan rate. Different or additional factors can be introduced as well.

To illustrate the range of conditions for dynamic change in the page scan rate, one current Bluetooth implementation is described. The most rapid page scanning interval is 11.25 ms, which is set by the Bluetooth specification. Under this condition the device that is scanning is doing so continuously. The most infrequent interval is greater than several seconds. Moreover, during the standby time between page scans the clocks between the two devices may drift, and if they drift too far then the page scans will fail. Therefore the maximum time interval between scans is not likely to be limited by the Bluetooth specification, but rather by the way the devices are used and the inherent physical limitations of the components with which the devices are built. The upper limit can lie in the 2-5 second range. As the technology progresses and new technologies are introduced the work in conjunction with Bluetooth or those that may replace Bluetooth but operate in accordance with the same principles that are described herein, these numbers may of course change.

In FIG. 4, the device power is on 402 and the call and UI states are idle 404 and so the Bluetooth pages scan rate is slow 406. A page scan event including a change in the UI occurs where the user dials an outgoing call 408. The call state is connecting and the UI state is active 410. Accordingly, the Bluetooth page scan rate can change to a fast or faster rate 412. A page scan event occurs including that the remote call receiver answers the call 414. Then both the call and the UI states are active 416 and the Bluetooth page scan rate can stay fast or change to a faster rate 418. As mentioned above, the changes in scan rates change dynamically. A page scan event occurs including that the user ends the call 420 so the call state is disconnecting and the UI state is still active 422. The Bluetooth pages scan rate becomes slow or slower 424. The call is disconnected 426 so that the call and UI states return to idle 404.

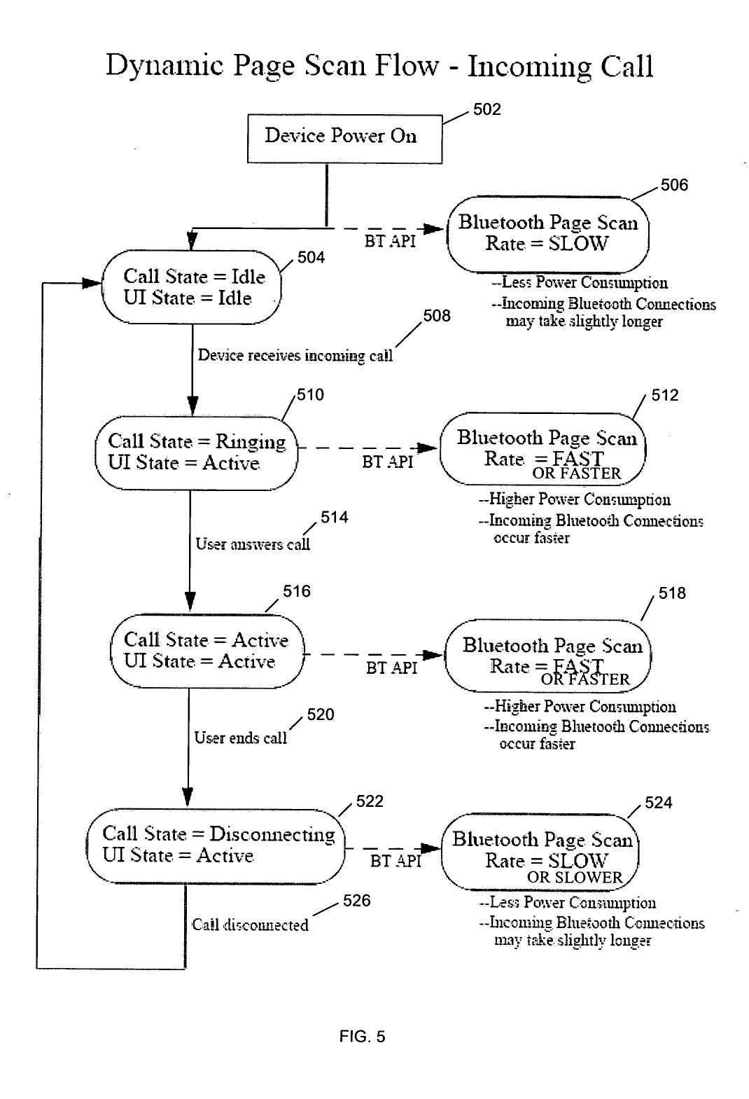

FIG. 5 shows an additional embodiment of dynamic page scan flow, here for an outgoing call. The device power is on 502 and the call and UI states are idle 504 and so the Bluetooth pages scan rate is slow 506. A page scan event including a change in the UI occurs where the device receives an incoming call 508. The call state is ringing and the UI state is active 510. Accordingly, the Bluetooth page scan rate can change to a fast or faster rate 512. A page scan event occurs including that the user answers the call 514. Then both the call and the UI states are active 516 and the Bluetooth page scan rate stays fast or can change to a faster rate 518. As shown here, the changes in scan rates change dynamically. A page scan event occurs including that the user ends the call 520 so the call state is disconnecting and the UI state is still active 522. The Bluetooth page scan rate becomes slow or slower 524. The call is disconnected 426 so that the call and UI states return to idle 504.

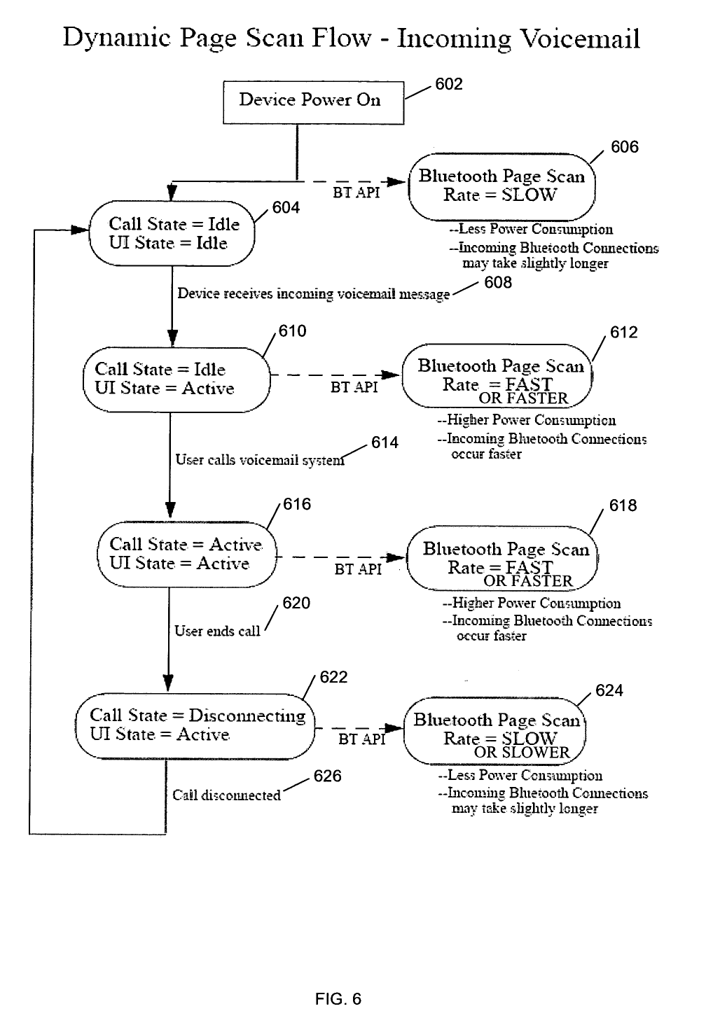

FIG. 6 shows another embodiment of a dynamic page scan flow, here for incoming voicemail. The device power is on 602 and the call and UI states are idle 604 and so the Bluetooth pages scan rate is slow 606. A page scan event including a change in the UI occurs where the device receives an incoming voicemail message 608. The call state is idle and the UI state is active 610. Accordingly, the Bluetooth page scan rate can change to a fast or faster rate 612. A page scan event occurs including that the user calls the voicemail system 614. Then both the call and the UI states are active 616 and the Bluetooth page scan rate stays fast or can change to a faster rate 618. Again, the changes in scan rates are dynamic. A page scan event occurs including that the user ends the call 620 so the call state is disconnecting and the UI state is still active 622. The Bluetooth pages scan rate becomes slow or slower 624. The call is disconnected 626 so that the call and UI states return to idle 604.

In this manner, different state conditions can affect the page scan rate to reduce power consumption and in some situations increase responsiveness. Combinations of state conditions may result in further variations in page scan intervals. Additional factors may add more variation to the states and provide further algorithmic bases for processing the different states. For example, “Push-to-Talk” (PTT) technology may experience response times in non-standard provider systems that are often not as fast as in standard provider systems. The inclusion of Bluetooth hands free devices, for example, into PTT systems implies that scanning intervals are often very fast (100-200 ms) in order to provide responsiveness that PTT users demand. Accordingly, dynamic adjustment of the page scanning intervals is applicable to situations where many different state conditions affect the page scan rate.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method for regulating power consumption during page scanning operations in a Bluetooth enabled communication device, the method comprising:
adjusting a first page scanning interval dynamically in the Bluetooth enabled communication device, such communication device having a power source and a processor that is configured to communicate according to a plurality of page scanning intervals; and
modifying the power consumption level of the power source according to the first page scanning interval.

2. A method as recited in claim 1 adjusting a second page scanning interval; and
modifying the power consumption level of the power source according to the second page scanning interval.

3. A method as recited in claim 1 wherein the first page scanning interval is for an incoming call.

4. A method as recited in claim 2 wherein the second page scanning interval is for disconnecting a call.

5. A method as recited in claim 4 wherein the first page scanning rate interval is smaller than the second page scanning rate and the power consumption of the second page scanning interval is smaller than the power consumption of the first page scanning interval.

6. A method as recited in claim 1 wherein the first page scanning interval is for an incoming voice mail.

7. A method as recited in claim 1 wherein the first page scanning interval is for an incoming an outgoing call.

8. A method as recited wherein the method is operable on a cellular telephone.

9. A method for regulating power consumption during page scanning operations in a Bluetooth enabled communication device, the method comprising:
assessing trigger events to dynamically adjust page scanning interval output values in the Bluetooth enabled communication device, such device having a power source and a processor that is configured to communicate with another device according to a plurality of page scanning intervals; and
adjusting a power consumption level in accordance with the page scanning interval output values.

10. A method as recited in claim 9 further comprising:
determining whether a page scanning interval output value is one of a long interval and a short interval.

11. A method as recited in claim 10 wherein a long interval requires less power consumption than a short interval.

12. A method as recited in claim 10 wherein a short interval requires more power consumption than a long interval.

13. A method as recited in claim 9 wherein there are a plurality of page scanning intervals and there are a plurality of power consumption levels is generated according to the page scanning intervals.

14. A method as recited in claim 9 wherein the Bluetooth enabled device is a cellular telephone.

15. A circuit for regulating power during page scanning operations in a Bluetooth enabled device, comprising;
a power source configured to provide power output to the device; and
a processor configured to adjust a page scanning interval in the Bluetooth enabled device to dynamically generate a plurality of page scanning intervals.

16. A circuit as recited in claim 15 wherein the power source is configured to provide power output to the device including a plurality of power output levels that corresponds to the plurality of page scanning intervals.

17. A circuit as recited in claim 16 wherein the plurality of page scanning intervals include values for outgoing call connecting,

18. A circuit as recited in claim 16 wherein the page scanning intervals include values for incoming voice mail.

19. A circuit as recited in claim 16 wherein the page scanning intervals include values for incoming call connecting.

20. A circuit as recited in claim 15 wherein the circuit is installed in a cellular telephone.
